(19) United States
(12) Patent Application Publication
(10) Pub. No.: US 2019/0318667 A1
(43) Pub. Date: Oct. 17, 2019

(54) Electronic Baggage Tag

(71) Applicant: British Airways Plc, Harmondsworth (GB)

(72) Inventors: Lewis FREEMAN, Berkshire (GB); Jeremy GARDNER, Berkshire (GB); Andrew ACTON, Berkshire (GB); Peter COOKE, West Drayton (GB); Martin THOMAS, West Drayton (GB)

(21) Appl. No.: 16/453,329

(22) Filed: Jun. 26, 2019

Related U.S. Application Data
(63) Continuation of application No. 15/552,229, filed on Aug. 18, 2017, now abandoned.

(30) Foreign Application Priority Data
Feb. 20, 2015 (GB) 1502879.8

(51) Int. Cl. G09F 3/20; G09F 3/14; A45C 13/42

(52) U.S. Cl. CPC G09F 3/208; G09F 2003/0254; A45C 13/42; G09F 3/14

(57) ABSTRACT

An electronic baggage tag (1), for attachment to a baggage item (30) having a handle, comprises a housing (3) for a display screen (2) and a fastening (4, 6) for removably securing the housing (3) to the handle (20) such that the display screen (2) remains visible during handling of the baggage item (30).

### CROSS-REFERENCE TO RELATED APPLICATION

This application is a continuation of and claims priority to U.S. application Ser. No. 15/552,229, filed Aug. 18, 2017, which is incorporated herein in its entirety by reference thereto.

### FIELD OF THE INVENTION

The present invention relates to a baggage tag having an electronic display or for housing an electronic display.

### BACKGROUND OF THE INVENTION

A conventional tag, for use in identification and tracking of baggage in airports and the like, comprises a self-adhesive strip that is printed with machine readable and human readable information which identifies a baggage item and the flight or journey on which the item is to be carried. The tag is typically printed by an operator at a check-in or baggage drop counter, and attached around a part of the baggage item to create a double-sided tag with machine-readable codes on both sides. The machine readable codes can then be read by an automated baggage transport system and used to look up further details on a database so as to enable the baggage item to be routed to the intended destination.

However, printed baggage tags may become damaged or may be positioned so that they cannot be read automatically. To overcome this problem, it has been proposed to replace paper baggage tags with radio-frequency-identification (RFID) tags, and some airports are now equipped with RFID readers to enable handling of RFID-tagged baggage. However, RFID tags cannot be read by conventional optical readers, as used in the majority of airports.

The applicant's patent publication GB-A-2500054 discloses an electronic baggage tag having an electronic display screen on both sides. Data can be loaded onto the tag e.g.

via an NFC interface and displayed as a barcode on both sides of the tag. This type of tag has been successfully tested; see the news item ‘British Airways Begins Customer Trials with Digital Bag Tags’, posted on 20 Nov. 2013 on the British Airways Media Centre, article ID 20131230125510. Another example of a double-sided electronic baggage tag is the eTag from FastTrack Company, announced in March 2014.

An electronic display screen is a relatively expensive component of a baggage tag, and providing screens on both sides of the tag adds to the cost. Moreover, even with display screens on both sides, an electronic bag tag may be positioned such that neither screen can be read during handling.

### STATEMENT OF THE INVENTION

According to one aspect of the present invention, there is provided an electronic baggage tag according to one or more of the accompanying claims.

### BRIEF DESCRIPTION OF THE DRAWINGS

Specific embodiments of the invention will now be described, purely by way of example, with reference to the accompanying drawings in which:

FIG. 1 is a perspective view of an electronic baggage tag in an embodiment;

FIGS. 2a to 2e illustrate a method of attachment of the electronic baggage tag of the embodiment to the handle of a baggage item;

FIGS. 3a to 3h are CAD line drawings of the electronic baggage tag of the embodiment, respectively in top, left, right, bottom, front, back, three quarter front, and three quarter back views; and

FIG. 4 is a schematic diagram of at least some of the electronic components of the baggage tag in the embodiment.

### DETAILED DESCRIPTION OF EMBODIMENTS

### Overview

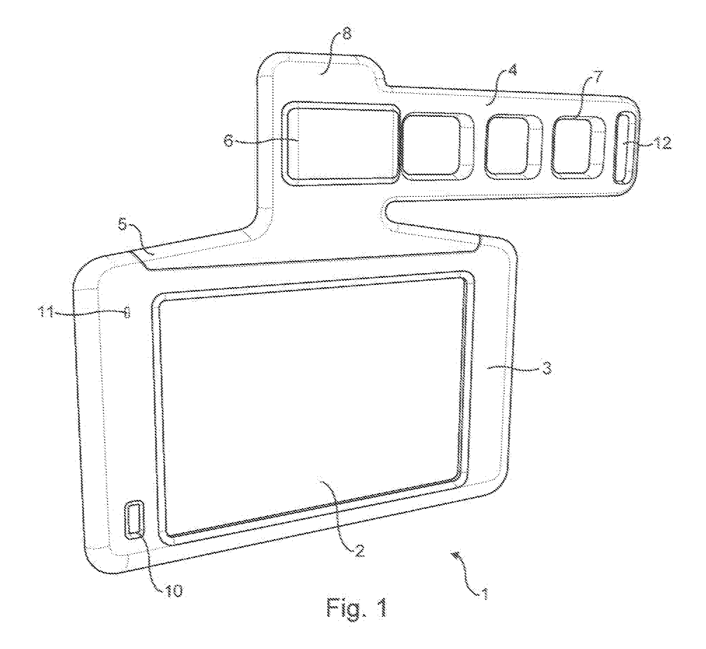

An electronic baggage tag 1 according to an embodiment of the invention will now be described with reference to FIG. 1. The baggage tag 1 comprises a housing 3 with a display screen 2 on the front face thereof. A flexible strap 4 is attached to one side of the housing 3 by means of an attachment portion 5 having a projection 8. The strap 4 extends substantially parallel to the side of the housing 3 to which the projection 8 is attached. The housing 3 is preferably substantially flat and planar. The projection 8 is preferably substantially coplanar with the housing 3. A boss 6 extends outwardly from the projection 8 and is arranged to fit within a location aperture 7 within the strap 4.

### Method of Use

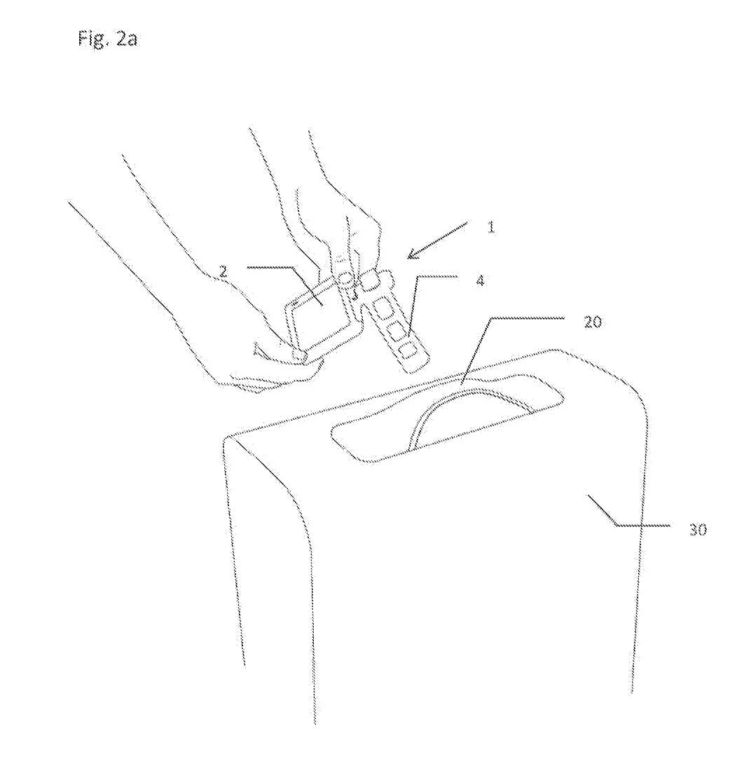

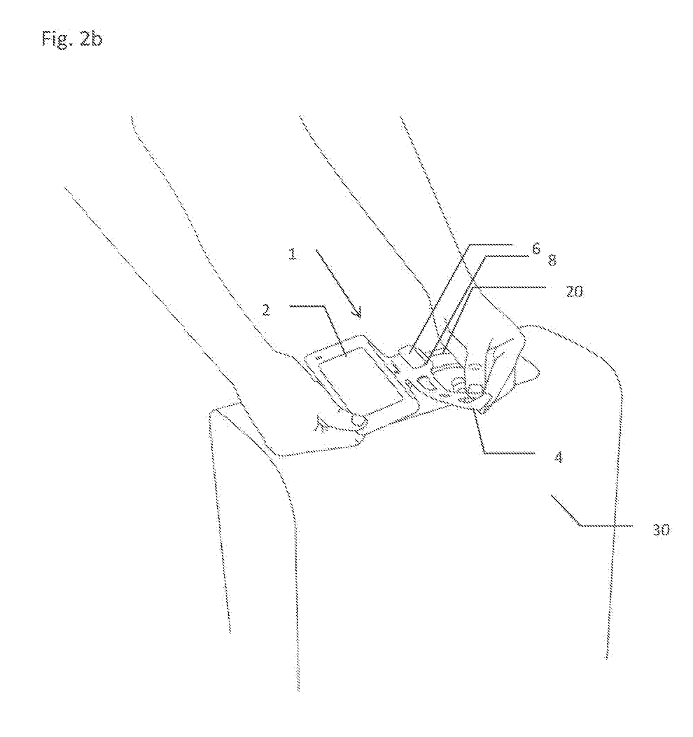

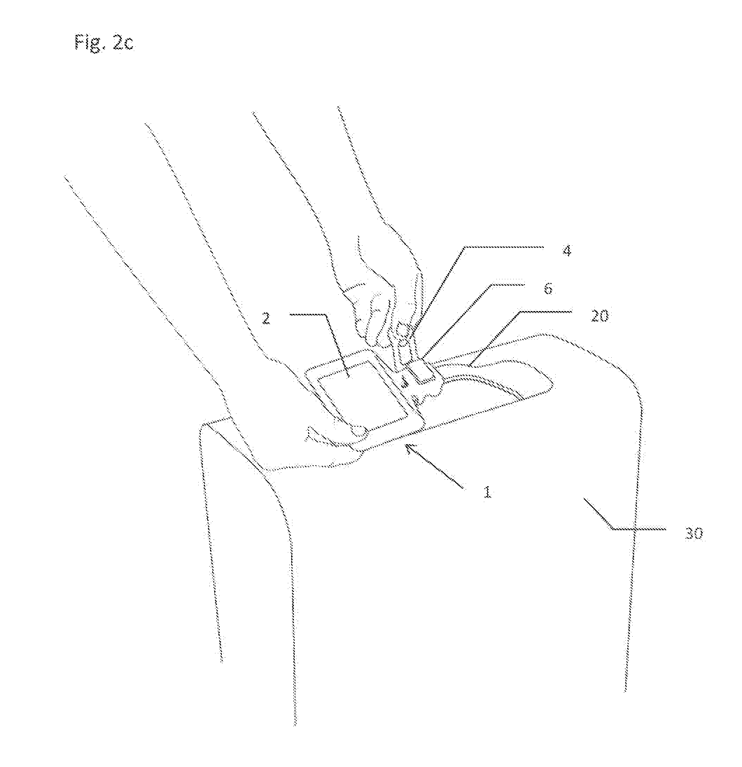

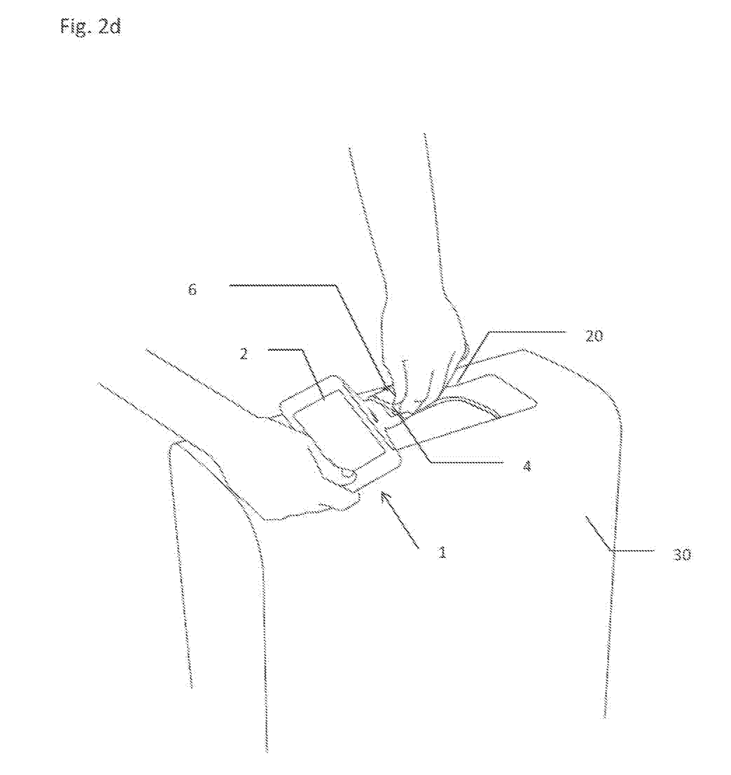

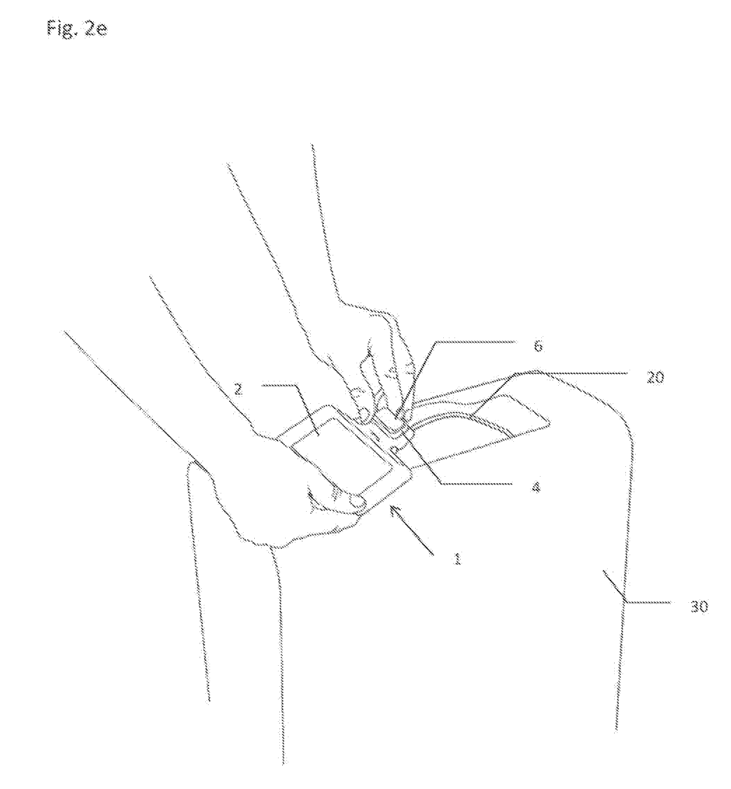

The baggage tag 1 is removably attachable to a handle 20 of a baggage item 30 by the method shown in FIGS. 2a to 2e. First, as shown in FIG. 2a, the baggage tag 1 is offered up to the handle 20, orientated with the display screen 2 facing outwards, away from the baggage item 30, and with the strap 4 extending towards one end of the handle 20, so as to leave the centre portion of the handle 20 free and avoid the baggage tag 1 obstructing the user's hand when holding the handle 20.

Next, as shown in FIG. 2b, the projection 8 is placed against the handle 20, with the boss 6 facing away from the handle 20, and the strap 4 extending substantially perpendicularly to from the handle 20. Next, as shown in FIG. 2c, the user wraps the strap 4 under and around the handle 20, while holding the baggage tag 1 in position so that the projection 8 remains against the handle 20. It should be noted that the strap 4, when wrapped around the handle 20, lies in a plane that does not intersect the part of the housing 3 in which the display 2 is housed.

Next, as shown in FIG. 2d, the user pulls the strap 4 tight over the boss 6 so that the location aperture 7 is aligned with the boss 6. Finally, as shown in FIG. 2e, the user forces the aligned location aperture 7 over the boss 6 so that the strap 4 is fastened around the handle 20.

As a result, the baggage tag 1 is secured to the handle 20 so that it should not flip over and obscure the display screen 2 during normal baggage handling. The housing 3 preferably rests against the upper surface of the baggage item 30 in a position to one side of the handle 20, so that the baggage tag 1 is protected from snagging or catching during handling.

### Details of Construction

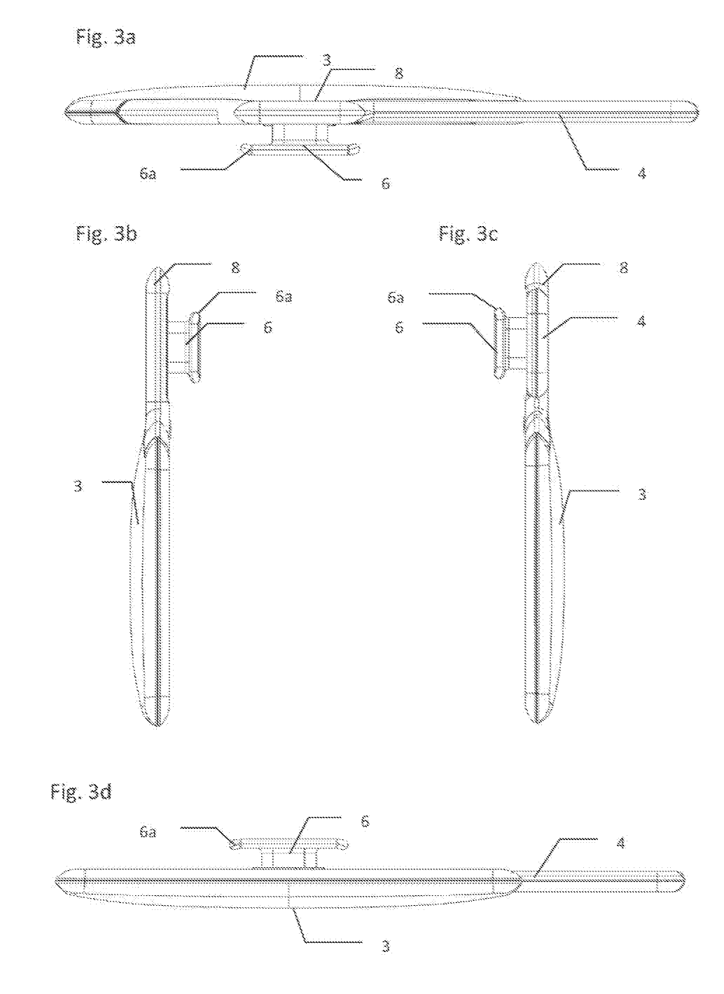

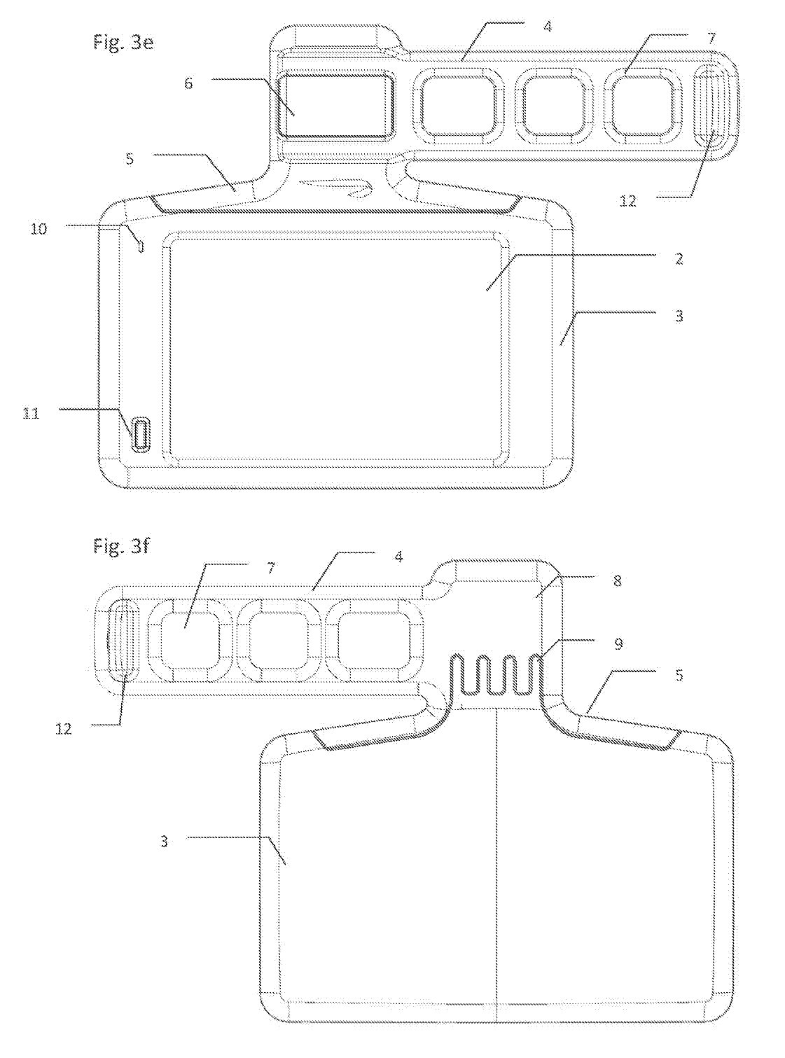

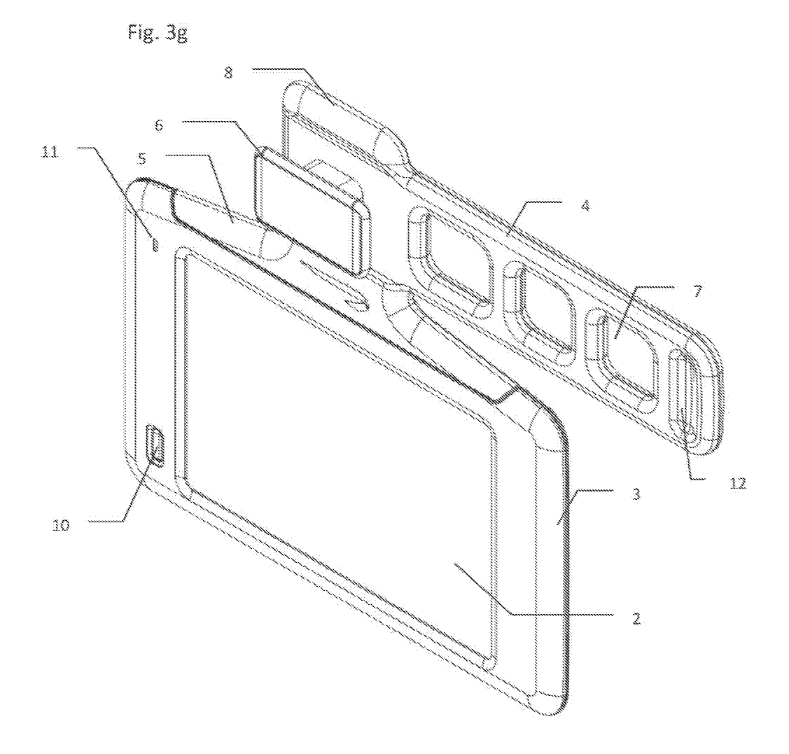

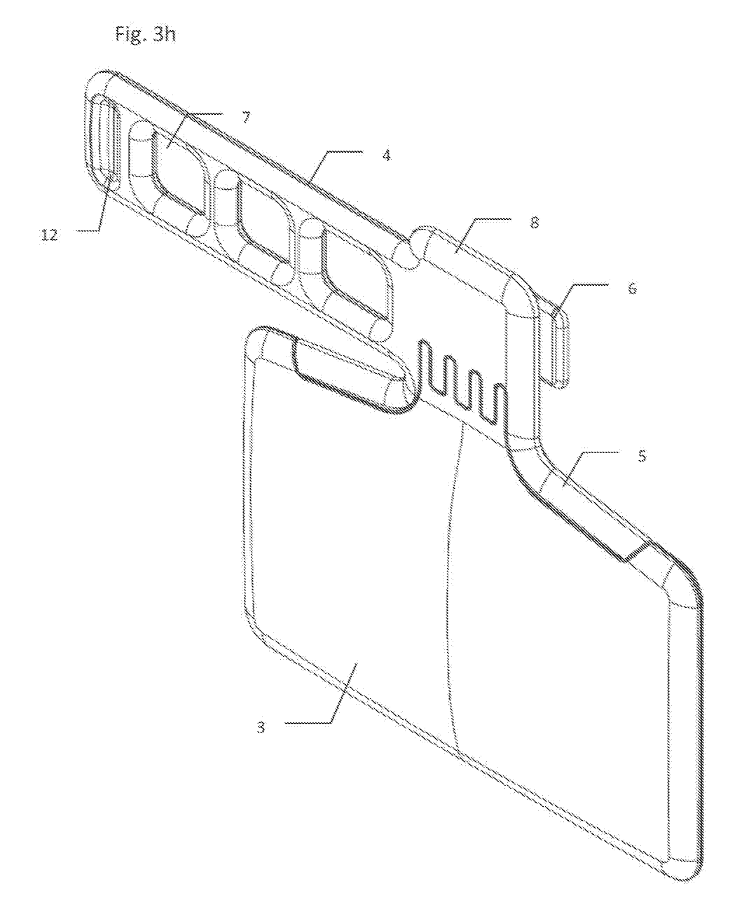

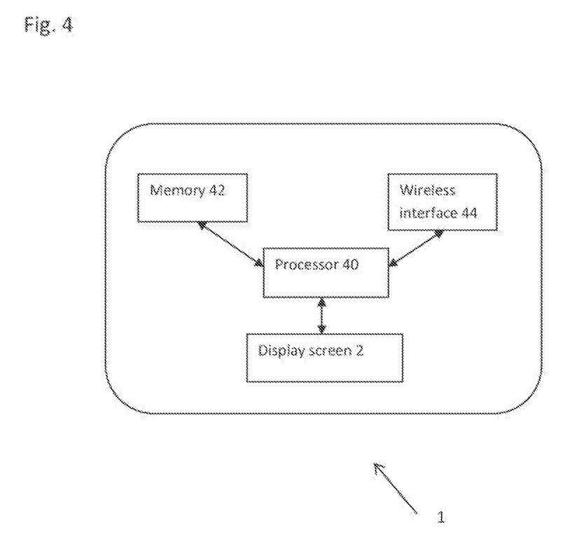

Examples of details of construction of the baggage tag in this embodiment will be described further with reference to FIGS. 3a to 3h and FIG. 4.

### Housing and Electronics

The housing 3 is preferably rigid, so as to protect the display screen 2 and other electronic components housed therein, as further described below. The housing 3 may be made of plastic, such as acrylonitrile butadiene styrene (ABS) and/or metal, such as aluminium, and/or a composite material such as a carbon fibre composite. The display screen 2 and/or other electronic components may be permanently fixed within the housing 3, or provided as a module removable from the housing 3. The front face of the housing 3 may have an approximately square or rectangular aperture through which the display screen 2 is visible. The housing 3 is preferably substantially flat and/or planar and preferably thin, for example less than 5 mm or less than 3 mm thick.

The housing 3 houses the display screen 2 and other components required for the operation of the electronic baggage tag 1 so as to display a machine-readable code and/or human-readable information on the display screen 2. The code may be a one-dimensional barcode, preferably displayed twice, in orthogonal directions, to facilitate scanning. The one-dimensional barcode may comply with the IATA standard for baggage tag barcodes (currently Resolution 792 of the Passenger Services Conference Resolutions Manual).

The display screen 2 preferably uses non-volatile display technology so that it does not require constant power, and may have very low power consumption since power is only required to change the state of the display screen 2. Examples of such display technology include electrophoretic ink (E Ink®). A power source, such as a rechargeable battery or capacitor, may be provided within the tag 1, or power may be provided to the tag 1 from an external source when the display state is to be changed.

Although the baggage tag 1 preferably includes a single display screen 2 on the front face, multiple discrete display screens 2 may be provided on the front face.

The baggage tag 1 may include one or more buttons 10, arranged for example to change the state of the display 2. The baggage tag 1 may include an indicator 11, such as an LED, arranged for example to indicate the state of the baggage tag 1.

The display screen 2 may be controlled by a processor 40 to display information and/or codes stored in a memory 42. A wireless interface 44 may be provided to allow the contents of the memory 42 to be read and modified, so as to provide or change the information displayed on the display screen 2. The wireless interface 44 may comprise a near-field communication (NFC), RFID (radio frequency identification), Bluetooth®, Bluetooth LE® or Zigbee® interface, for example.

The tag 1 may include one or more further components dependent on the required functionality, such as a GPS (Global Positioning System) or beacon signal receiver, a microphone and/or speaker, a sensor, a camera and so on.

### Fastening

The strap 4 is made of flexible and preferably resilient material, such as silicone. The strap 4 and attachment portion 5, optionally including the projection 8, may be formed of a single piece and may be moulded onto a contact portion 9 of the housing 3, as shown as a digitated portion in FIG. 3f. Optionally, a strengthening portion (not shown) may extend within the projection 8, to prevent the projection 8 bending when in use. The strengthening portion may form part of the housing 3.

The boss 6 is preferably made of rigid material and may be rigidly attached to the strengthening portion and/or to the housing 3. As shown in FIGS. 3a to 3d, the boss 6 has a projecting rim or flange 6a at or around the front end so as to secure the location aperture 7. The location aperture 7 may have at least one dimension slightly smaller than the corresponding dimension of the flange 6a, so that the location aperture 7 must be stretched to fit over the flange 6a, thus securing the strap 4.

Preferably, the boss 6 has a substantially planar front face that is visible when the tag 1 is secured to the handle 20. This front face may be coloured and/or decorated, for example to show the loyalty class (e.g. Blue, Bronze, Silver and Gold) of the owner. The front face may comprise a removable visible portion so that the colour or decoration may be changed. Alternatively, a secondary electronic display may be provided on the front face, for example a display of changeable colour.

At least part of the wireless interface 44 may be provided in the boss 6; for example, an NFC or contactless interface in the boss 6 may provide a convenient point on which to swipe a contactless reader/writer.

A locking mechanism may be provided in the boss 6, to prevent unauthorised removal of the tag 1 from the handle 20. The boss 6 may be moveable (e.g. rotatable or slidable) and lockable so that the location aperture 7 cannot be removed from the boss 6 when locked. The locking mechanism may comprise a mechanically or electronically actuated lock.

The strap 4 may have a grip portion 12 located at the end remote from the projection 8, so as to facilitate gripping of the end of the strap 4 during attachment. The grip portion 12 may be a projection or indentation on one or both faces of the strap 4.

The drawings show a plurality of apertures within the strap 4; one or more of these may be location apertures 7 at different positions along the strap 4, to allow adjustment for different sizes of handle 20, but one or more other apertures may not be location apertures 7 and may be purely decorative or provided to save weight or to increase the flexibility or resilience of the strap 4.

### Alternative Fastenings

In some alternative embodiments, the strap 4 and projection 8 may be provided but the boss 6 and/or location aperture(s) 7 may differ from those described above. For example, one or more hooks or other shaped projections may be provided instead of the boss 6, with correspondingly shaped or positioned location aperture(s). Alternative means for fastening the strap 4 to the projection 8 may be provided, such as a buckle, snap fastener, hook-and-loop (e.g. Velcro®) fastener and the like, provided the fastening is sufficiently secure to hold the tag 1 in position during handling. Instead of the strap 4, a clip or other fastening may be provided for securing the projection 8 to the handle 20.

### Alternative Embodiments

The embodiments described above are illustrative of rather than limiting to the present invention. Alternative embodiments apparent on reading the above description may nevertheless fall within the scope of the invention.

1-15. (canceled)

16. An electronic baggage tag for removable attachment to a handle of a baggage item, the tag comprising:
a rigid housing for a display screen;
a projection extending from one side of the housing;
a flexible strap permanently attached at a first end thereof to the projection and extending in a direction substantially parallel to the side of the housing from which the projection projects;
wherein the flexible strap is arranged to pass around the handle and to be removably attached at or around a second end thereof to the projection so as to secure the projection against the handle; and
wherein a part of the rigid housing extends within the projection so as to strengthen the projection against bending when in use.

17. The tag of claim 16, wherein a proximal end of the strap is attached to the projection.

18. The tag of claim 16, wherein the projection includes a fastening portion for engagement with the flexible strap at or around the second end thereof.

19. The tag of claim 18, wherein the fastening portion includes a boss extending outwardly from the projection, for engagement with an aperture in the flexible strap.

20. The tag of claim 19, wherein the boss has a substantially planar front face.

21. The tag of claim 19, wherein the boss has a projecting rim or flange around the front face thereof.

22. The tag of claim 16, including the display screen.

23. The tag of claim 22, wherein the display screen comprises a module removable from the housing.

24. The tag of claim 16, wherein the projection is substantially coplanar with the housing.

25. The tag of claim 16, including a locking mechanism for locking the housing to the handle.

26. The tag of claim 16, including one or more buttons arranged to change the state of a display on the display screen.

27. The tag of claim 16, including an indicator arranged to indicate a state of the tag.

28. The tag of claim 25, wherein the locking mechanism comprises a buckle or snap fastener.

29. The tag of claim 16, wherein the part of the rigid housing that extends within the projection includes a contact portion to which the flexible strap is attached.

30. A method of securing an electronic baggage tag to a baggage item, the electronic baggage tag comprising a rigid housing for a display screen, a projection extending from one side of the housing and a flexible strap permanently attached at a first end thereof to the projection and extending in a direction substantially parallel to the side of the housing from which the projection projects; wherein a part of the rigid housing extends within the projection so as to strengthen the projection against bending when in use; the method comprising:
positioning the baggage tag against the baggage item with the display screen facing outwards, passing the flexible strap around the handle; and
removably attaching the flexible strap at or around a second end thereof to the projection so as to secure the projection against the handle.

31. A method of manufacturing an electronic baggage tag, the method comprising:
providing a rigid housing for a display screen, the housing having a projection extending from one side of the housing; and
attaching a flexible strap onto the rigid projection such that the strap extends in a direction substantially parallel to the side of the housing from which the projection projects; wherein a part of the rigid housing extends within the projection so as to strengthen the projection against bending when in use.

32. The method of claim 31, wherein the flexible strap is moulded onto a contact portion of the projection.

33. The method of claim 32, wherein the contact portion is a digitated portion.
